(19) United States
(12) Patent Application Publication
(10) Pub. No.: US 2008/0002622 A1
(43) Pub. Date: Jan. 3, 2008

(54) Apparatus, method and computer program product providing handover with selective bi-casting by network node

(75) Inventor: Otso Auterinen, Helsinki (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/479,845

(22) Filed: Jun. 30, 2006

(51) Int. Cl. H04Q 7/00

(52) U.S. Cl. 370/331

(57) ABSTRACT

A method includes, during a handover of a user equipment (UE) from a first base station (BS1) to a second base station (BS2), determining at an anchor node at least one property of a downlink packet flow, and bi-casting downlink packets in the downlink packet flow to BS1 and BS2 only when the at least one property of the downlink packet flows is determined to comprise at least one predetermined property. A network node includes means, responsive during a handover of a user equipment (UE) from a first base station (BS1) to a second base station (BS2), for determining at least one property of a downlink packet flow; and means, responsive to the determination, for bi-casting downlink packets in the downlink packet flow to BS1 and BS2 only when the at least one property of the downlink packet flows is determined to comprise at least one predetermined property.

### TECHNICAL FIELD

The exemplary and non-limiting embodiments of this invention relate generally to wireless communications systems, methods, computer program products and devices and, more specifically, relate to hand over or hand off (HO) procedures executed when a user equipment (UE) changes cells.

### BACKGROUND

The following abbreviations are herewith defined:
3GPP Third Generation Partnership Project
BS Base Station, may also be referred to as a Node-B
DL Downlink (BS to UE)
GPRS General Packet Radio Service
GTP GPRS Tunneling Protocol
GW Gateway (aGW=Active GW)
LTE Long Term Evolution
NAT Network Address Translation
DNAT Destination NAT (e.g., with netfilter)
MSC Mobile Switching Center
NW Network
PDCP Packet Data Convergence Protocol
PS Packet Switched
QoS Quality of Service
RAN Radio Access Network
RLC Radio Link Control
RLID Radio Link Identification
RNC Radio Network Control
RNS Radio Network Sub-system
RRC Radio Resource Control
SAE System Architecture Evolution
UE User Equipment
UL Uplink (UE to BS)
UMTS Universal Mobile Telecommunications System
UTRAN UMTS Terrestrial Radio Access Network
E-UTRAN Evolved UTRAN
VoIP Voice over Internet Protocol (IP)

The LTE and SAE of 3GPP and other cellular networks are particularly amenable to the use of a flat, two layer system architecture. In a flat architecture an inter-BS HO (from a first, source BS to a second, target BS) of a UE takes place by switching a tunnel in an anchor point in an anchor node that is typically located in a network GW. It is also noted that there exist non-tunneling methods with the same effect as tunnel switching for packet forwarding, e.g. DNAT-based switching of the packet route to the new BS could be used in place of tunnel switching. During HO an inter-BS forwarding of control and user plane information may be used. However, the delay requirements and cost related to providing sufficient connectivity between BSs makes the use of inter-BS communication less than desirable. This is true at least for the reason that a need exists to quickly begin the delivery of DL data to the target BS to ensure minimal probability of a packet loss occurring for the UE during HO.

Inter-BS forwarding and a basic bi-casting procedure executed by the anchor point have been previously proposed.

Reference may be had to 3GPP TR 25.936 V4.0.1 (2001-13), “Handovers for real-time services from PS Domain”, where bi-casting is defined to be a capability of a node to receive original data, and to send this data in its original form over two different paths.

Reference may be had to 3GPP TR 21.905, V6.9.0 (2005-06), “Vocabulary for 3GPP Specifications”, where HO is defined as a transfer of a user's connection from one radio channel to another (can be the same or a different cell), and is also defined as a process in which the RAN changes the radio transmitters or radio access mode or radio system used to provide bearer services, while maintaining a defined bearer service QoS.

Reference may also be had to a publication entitled: “Handover in Packet-Domain UMTS”, Shen Qingguo, TechOnLine Publication, Feb. 8, 2002, that proposes seamless SRNS relocation mechanisms for UMTS Conversational and Streaming traffic. These two types of traffic classes (QoS classes) are deemed to be the most delay sensitive, followed by the less delay-sensitive Interactive and Background classes. It is said that by extending the UMTS data link protocols GTP-U/PDCP/RLC, a synchronization is made of the traffic streams in the new and old communication paths. Radio signal macro-diversity and packet bi-casting are said to guarantee multimedia traffic QoS. FIG. 4 of this publication shows a case of synchronous packet stream merging, where a 3G-MSC bi-casts packets to two RNSs.

It can be noted that by its very nature the bi-casting of data packets consumes more network bandwidth and resources than does a packet flow through but one network path.

### SUMMARY OF THE EXEMPLARY EMBODIMENTS

The foregoing and other problems are overcome, and other advantages are realized, through the use of the exemplary embodiments of this invention.

In accordance with the exemplary embodiments of this invention there is provided a method that includes, during a handover of a user equipment (UE) from a first base station (BS1) to a second base station (BS2), determining at an anchor node at least one property of a downlink packet flow, and bi-casting downlink packets in the downlink packet flow to BS1 and BS2 only when the at least one property of the downlink packet flow is determined to comprise at least one predetermined property.

Further in accordance with the exemplary embodiments of this invention there is provided a network node that comprises: means, responsive during a handover of a user equipment (UE) from a first base station (BS1) to a second base station (BS2), for determining at least one property of a downlink packet flow; and means, responsive to the determination, for bi-casting downlink packets in the downlink packet flow to BS1 and BS2 only when the at least one property of the downlink packet flow is determined to comprise at least one predetermined property.

Further in accordance with the exemplary embodiments of this invention there is provided a computer program product embodied in at least one computer readable storage media. The computer program product includes instructions, the execution of which by at least one data processor of a network node results in operations that include: during a handover of a user equipment (UE) from a first base station (BS1) to a second base station (BS2), determining at an anchor node a property of a downlink packet flow; and bi-casting downlink packets in the downlink packet flow to BS1 and BS2 only when the at least one property of the downlink packet flow is determined to comprise at least one predetermined property as the property.

Further in accordance with exemplary embodiments of the disclosed invention, an apparatus is disclosed that includes one or more memories including program code. The apparatus also includes one or more processors coupled to the one or more memories. The one or more data processors is configured when executing the program code to perform the following operations: during a handover of a user equipment (UE) from a first base station (BS1) to a second base station (BS2), determining at least one property of a downlink packet flow; and bi-casting downlink packets in the downlink packet flow to BS1 and BS2 only when the at least one property of the downlink packet flow is determined to comprise at least one predetermined property.

### BRIEF DESCRIPTION OF THE DRAWINGS

In the attached Drawing Figures:

FIG. 1 shows a simplified block diagram of various electronic devices that are suitable for use in practicing the exemplary embodiments of this invention.

FIG. 2 is a message flow diagram that is illustrative of the exemplary embodiments of this invention, and which shows message flow for HO with selective bi-casting by an anchor GW, with buffering for predictive bi-casting.

FIGS. 3, 4, and 5 are each a logic flow diagram illustrative of exemplary embodiments of this invention.

FIG. 6 is a block diagram of another exemplary anchor GW.

### DETAILED DESCRIPTION

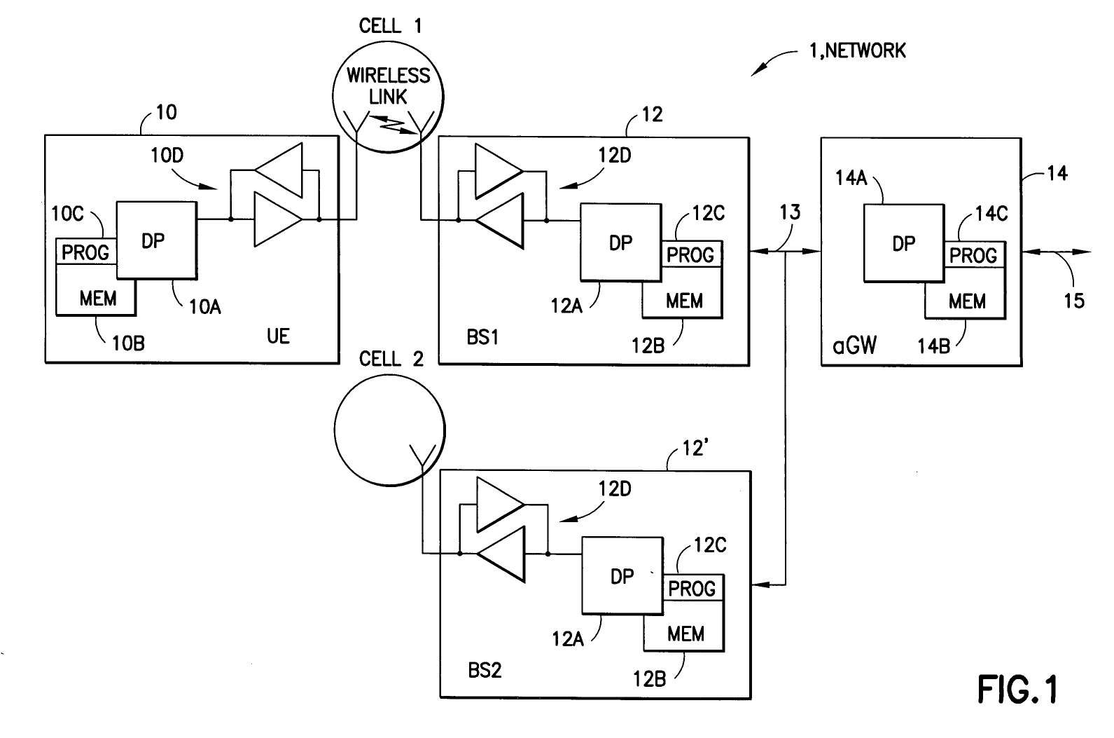

Reference is made first to FIG. 1 for illustrating a simplified block diagram of various electronic devices that are suitable for use in practicing the exemplary embodiments of this invention. In FIG. 1 a wireless network 1 is adapted for communication with a UE 10 via a first BS (BS1), referred to in the drawing as BS 12. The network 1 may include a GW, referred to herein as the aGW 14, or other controller function. The UE 10 includes a data processor (DP) 10A, a memory (MEM) 10B that stores a program (PROG) 10C, and a suitable radio frequency (RF) transceiver 10D for bidirectional wireless communications with the Node B 12, which also includes a DP 12A, a MEM 12B that stores a PROG 12C, and a suitable RF transceiver 12D. The BS 12 is coupled via a data path 13 to the aGW 14 that also includes a DP 14A and a MEM 14B storing an associated PROG 14C. The aGW 14 is typically coupled to other network 1 components (not shown) by the same or another data path 15. Note that packets that are to be sent on the DL to the UE 10 will typically be received from some source of packets via data path 15. The functionality of these other network nodes is not germane to an understanding of this invention, and they are not discussed further. At least one of the PROGs 10C, 12C and 14C is assumed to include program instructions that, when executed by the associated DP, enable the electronic device to operate in accordance with the exemplary embodiments of this invention, as will be discussed below in greater detail.

Shown in FIG. 1 is also a second BS (BS2), also referred to in the drawing as BS 12′, it being assumed that the first BS (BS1) establishes a first cell (Cell 1) and the second BS (BS2) establishes a second cell (Cell 2), and that the UE 10 is capable of a HO from one cell to another. In FIG. 1 the Cell 1 may be assumed to be a currently serving cell and the BS1 as the source BS, while Cell 2 may be a neighbor or target cell to which HO may occur, and the BS2 is thus the target BS. Note that while shown spatially separated, Cell 1 and Cell 2 will typically be adjacent and/or overlapping, and other cells will typically be present as well.

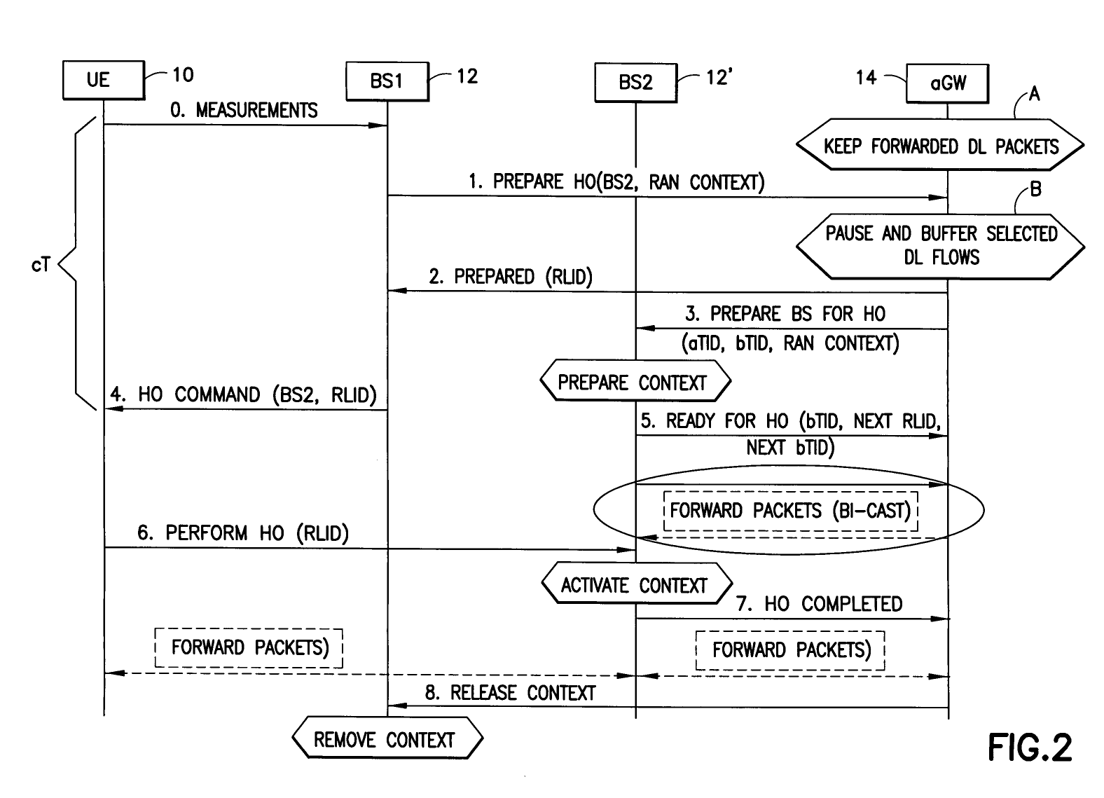

As will be made apparent below in the description of FIG. 2, The exemplary embodiments of this invention may be implemented by computer software executable by the DP 10A of the UE 10, the DPs 12A of the BS1 and BS2, and the DP 14A of the aGW 14, or by hardware, or by a combination of software and/or firmware and hardware.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

Having thus introduced on suitable but non-limiting technical context for the practice of the exemplary embodiments of this invention, the exemplary embodiments will now be described with greater specificity.

In accordance with the exemplary embodiments of this invention an anchor point in the core NW, such as the aGW 14, is used for bi-casting of downlink user data to the source and target BSs (BS1, BS2), where bi-casting is used selectively as a function of flow QoS.

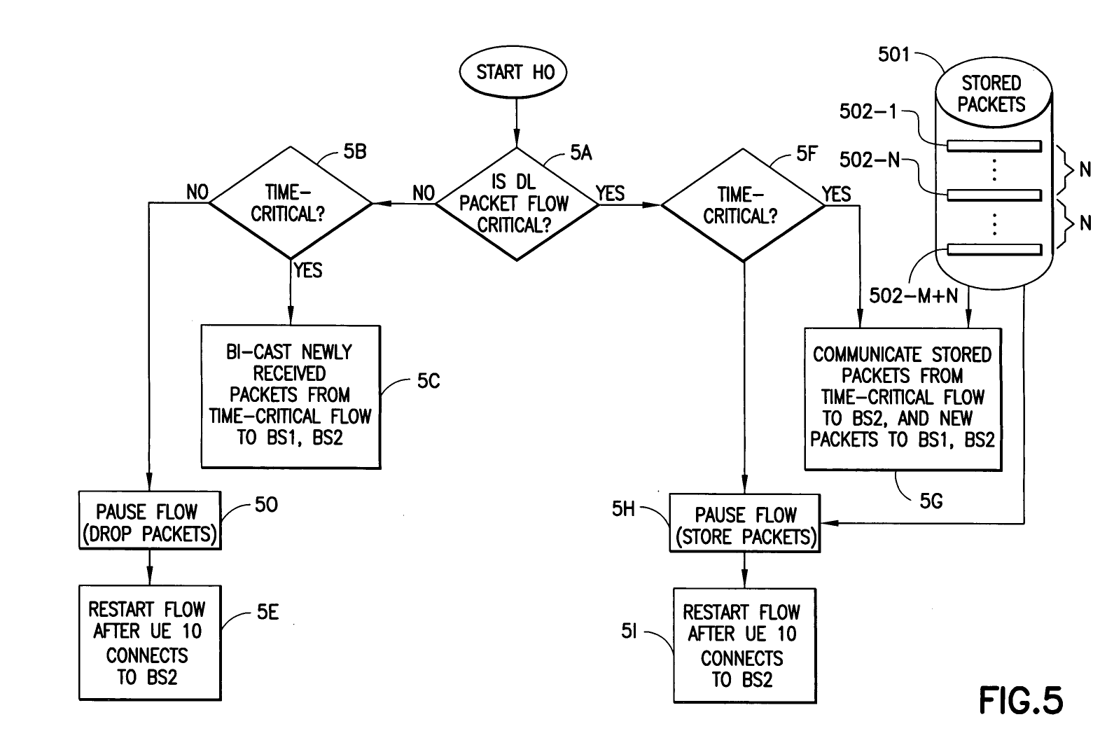

More specifically, for time-critical packet flows the bi-casting to BS1 and BS2 is activated immediately when HO preparation is initiated. Thus, data packets that arrive for the flow once bi-casting is initiated will be communicated to both BS1 and BS2. Being time-critical is one property of a flow. As described in more detail below in reference to FIG. 5, for time-critical flows with large packets, or some other property that makes delivery to the UE 10 slow or more error prone, the bi-casting is started by sending packets that were already previously sent to the source BS (BS1). For this purpose the anchor node stores packets for some period of time after they have been delivered to the serving BS (BS1) so that they can be subsequently sent to the target BS (BS2). However, for those flows that can tolerate delay, the bi-casting is selectively not activated, and downlink packet delivery by the anchor node is paused in response to the initiation of HO. Packet delivery to the target BS (BS2) is then resumed after the HO of the UE 10 is completed.

A non-limiting example of a DL packet flow having a property of being time-critical may be packets associated with a real-time or approximately real-time event, such as a VoIP call, or a streaming video or audio download (e.g., events associated with the above-mentioned Conversational and Streaming QoS classes). The classes discussed above are also properties of a DL packet flow. Meanwhile non-limiting examples of a non-time-critical packet flow, another property of a DL packet flow, may be a download to the UE 10 of a web page from an Internet server, or email delivery, or typical interactive operation (e.g., events associated with the above-mentioned Interactive and Background QoS classes). Another possible type of property of a DL packet flow is a DL packet flow that is considered to be (e.g., marked as) critical. Critical DL packet flows are those flows that require secure delivery, i.e., low drop probability, with potentially slow delivery (e.g., on transport data path 13 of FIG. 1 or over the wireless link of FIG. 1). Packet flow for streaming video is one example of a critical DL packet flow. A packet flow that has a property of being critical may also have the property of being time-critical. It is noted that the Streaming QoS class, e.g., may be considered in different embodiments to have a property of critical but not time-critical, to have properties of critical and time-critical, or to have a property of time-critical but not critical.

Packet sequence numbering is used to control the DL packet delivery from the BS to the UE 10. Sequence number-based delivery from the anchor node is preferably used for the paused DL flows. Sequence numbering is also used for timing of the HO command by informing the source BS (BS1) of the initiation of bi-casting by reporting the related sequence numbers per flow from the anchor point.

In this approach, in accordance with the exemplary embodiments of this invention, packet delivery to the UE 10 is assured since ‘recent historical’ packets are sent as well (bi-cast) to the target BS (BS2). In addition, transport usage is optimized since delay-tolerant packets are not bi-cast, thereby conserving communication bandwidth. In addition, it can be appreciated that low capacity BSs do not require additional link capacity because of bi-casting, and BS-BS forwarding problems are avoided.

Referring to FIG. 2, a description of the various message exchanges, labeled as 1-7 (and the optional message 8) for convenience, will now be provided. Note that each messageₙ may be composed of one message or a plurality of messages, possible both in the UL and DL directions. The message(s) labeled as 0 refer to the conventional measurement reporting from the UE 10 to the source BS (BS1) at the start of HO. It may be assumed that at this point at least one DL packet flow is in process prior to the HO, and that the UE 10 QoS requirements for on-going packet flow(s) are known to the aGW 14.

Message(s) 1. This message is sent from the source BS (BS1) to the aGW 14, and includes information to prepare for the HO (e.g., information pertaining to BS2 and the RAN Context). The sequence number of the last packet in each (QoS) flow assumed to be successfully transmitted to the UE 10 before the HO are also sent by the BS1. Note that prior to receipt of Message1 (at operation A), the aGW 14 is in one embodiment constantly saving (e.g., buffering) DL packets that are sent to BS1, and that after the receipt of Message 1 the aGW 14 has paused and started to buffer selected (including non-time-critical) DL flows (at operation B). Data packets that are constantly saved include time-critical packets (e.g., need to be delivered within a time period) and critical packets (e.g., are to be securely delivered but might not be time-critical), where critical, non-critical, and time critical are properties associated with the packets and their corresponding DL packet flow.

Message(s) 2. The aGW 14 informs the source BS(BS1) of the prepared RLID, and also of the preparation to begin bi-casting by indicating on a per flow basis the sequence number of first packet to be bi-cast. Additionally, the packet flow or flows where DL forwarding by the aGW 14 has been paused are indicated to the BS1. The aGW 14 makes the decision to pause a flow according to the QoS class of the flow (e.g., does the flow have the property of being time critical, or being non-time critical, e.g., is best effort delivery specified?). In order to be able to begin the bi-casting operation from an earlier packet (for a time critical flow), the aGW 14 may have previously chosen to buffer packets sent to the BS1 as a preparatory action for the coming HO (operation A).

Message(s) 3. In addition to preparing the target BS (BS2) for the coming HO (e.g., by sending transaction identifiers-and RAN Context), the aGW 14 informs BS2 of which packet flow(s) will (probably) be bi-cast before HO completion.

Message(s) 4. The BS1 commands the UE 10 to perform HO to BS2. The identifications (e.g. sequence numbers) of the first packets expected to be available from BS2 are also communicated to the UE 10. It is noted that a sequence number may have been already delivered with each packet to UE, and sequence numbers need not be separately communicated. In this case the UE assumes that the packet with next sequence number is available from BS2.

Message(s) 5. The BS2 informs the aGW 14 about those flows for which it is ready to receive packets for DL forwarding, and in response the aGW initiates forwarding of packets (bi-casting of the packets previously determined to be time critical). These bi-cast data packets are temporarily buffered in the memory 12B of the BS2 12′, as the HO to the UE 10 is not yet fully completed. Note that this bi-casting operation assumes that the same packets are being sent to BS1 and to BS2.

Message(s) 6. The UE 10 performs the HO and attaches to BS2. The UE 10 informs the BS2 on a per flow basis the sequence number of last received packet (from BS1 prior to the HO). BS2 also activates the UE 10 context, and starts forwarding UL packets and the DL packets already available in BS2.

Message(s) 7. The BS2 informs the aGW 14 of the HO completion, and also informs the aGW 14 of the sequence numbers of those flows not previously activated in the message exchange 5. The aGW 14 initiates forwarding of packets for those flow(s) from the indicated sequence number, and these packets, as well as the packets previously bi-cast at 5 (if needed), are forwarded to the UE 10. Note that if the last-received sequence number of a time-critical packet that is sent by the UE 10 indicates that not all packets forwarded by BS1 were received, then the BS2 will likely have already received the “missing” packet as part of the previously bi-cast packets from the aGW 14, and may then begin the forwarding of packets from one of the earlier, bi-cast packets previously received and stored in the memory 12B. Note that in this case latency is reduced for time-critical packets, as the BS2 already has the “missing” packet and can begin the forwarding immediately, without having to contact the aGW 14 (or the BS1), to obtain the missing packet.

It is noted that data packets and corresponding flows that have been delayed instead of being bi-cast are sent to the BS2 after message 7 to BS2. It is also noted that the BS1 could initiate HO preparation to several targets (e.g., several BS2s), and all or all but one of the preparations may be cancelled. If all preparations are cancelled, flows are restarted for DL delivery via BS1.

Message(s) 8. The aGW 14 signals the BS1 to release the previous context for the UE 10, which is then removed by the BS1. At this time the UE 10 is already connected to the BS2 and is receiving both the time critical and the previously paused and buffered non-time critical packets from BS2. In an exemplary embodiment, this message is optional, and the resources may be cleared by BS1 after message 4. Use of this message (message 8) enables a state of UE context in BS1, which is same as state of UE context in BS2 after message 5 (e.g., Ready-for-HO). The advantage of these equal states is that a HO back to BS1 may be initiated by BS2—in stead of completion via message 7—with message 4 to UE. For this optimization the message 3 (or message 6, or both) has to contain the identity of BS1.

As a further optimization, more than two base stations may have the UE in Ready-for-HO state. Each message 1 brings the UE to this state, and message 7 causes UE context to be released from a BS. For this optimization, message 3 contains a list of base stations which will—after the message 6—have the context in Ready-for-HO and message 7 contains a list of base stations in which the context should be released.

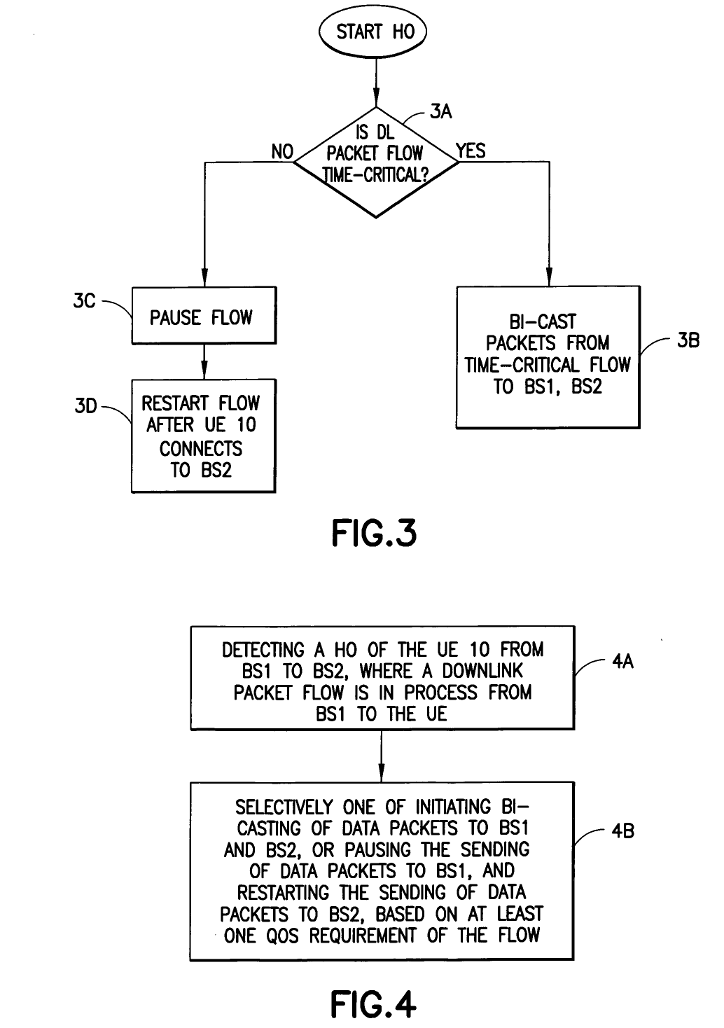

Referring to the logic flow diagram of FIG. 3 it may be appreciated that the exemplary embodiments of this invention provide a method that includes, during a handover of the UE 10 from BS1 to BS2, determining at an anchor node (e.g., the aGW 14) if a downlink packet flow is a time-critical flow (Block 3A) (e.g., if the packet flow has a property of being time-critical); and if it is, selectively bi-casting downlink packets to BS1 and BS2 only for a packet flow determined to be time-critical (Block 3B).

In this context a time-critical flow may be one associated with a real-time or substantially real-time event (DL voice, video or audio packet flows, as non-limiting examples). If a certain packet flow is determined to have a property of not being time-critical, the method further includes pausing sending of the certain packet flow (Block 3C) and restarting the sending of the packet flow after the UE 10 has connected to BS2 (Block 3D). It is noted that incoming packets are typically dropped in Block 3C.

Referring to the logic flow diagram of FIG. 4 it may be appreciated that the exemplary embodiments of this invention further provide a method that includes detecting a HO of the UE 10 from BS1 to BS2, where a downlink packet flow is in process from BS1 to the UE (Block 4A); and selectively one of initiating bi-casting of data packets to BS1 and BS2, or pausing the sending of data packets to BS1, and restarting the sending of data packets to BS2, based on at least one QoS requirement of the flow (Block 4B). The at least one QoS requirement is a property of the flow.

Referring to the logic flow diagram of FIG. 5 it may be appreciated that the exemplary embodiments of this invention further provide a method that includes, during a handover of the UE 10 from BS1 to BS2, determining if a DL packet flow is critical (Block 5A) (e.g., has a property of being critical). Critical DL packet flows are those flows that require secure delivery, i.e., low drop probability, with slow delivery (e.g., on transport data path 13 of FIG. 1 or over the wireless link of FIG. 1). Packet flow for streaming video is one example of a critical DL packet flow. Blocks 5B-5E are similar to the blocks of the method shown in FIG. 3. If the DL flow is not critical (Block 5A=N) but is time-critical (Block 5B=Y), then newly received packets (e.g., packets that have not been previously sent to BS1 and typically not stored in memory 301) in the time-critical DL packet flow are bi-cast to both BS1 and BS2 (Block 5C). If the DL flow is not critical (Block 5A=N) and not time-critical (Block 5B=N), the DL packet flow is paused and packets are dropped (Block 5D) until flow is restarted after UE 10 connects to BS2 (Block 5E).

For critical flows, data packets 502 that have been communicated to the BS1 are stored in memory 501, which is accessible (e.g., as memory 14B) by the aGW 14 of FIG. 1. Typically, the data packets 502 are stored for some predetermined time period, e.g., after the data packets 502 are transmitted to BS1 by the aGW 14. New packets that arrive will then take the place of data packets 502 already in memory 501. For instance, the aGW 14 may store N data packets 502-1 through 502-N, with one packet being the oldest packet (i.e., been stored the longest) and another packet being the newest packet (i.e., being stored the least amount of time). The number N in an embodiment is based on time after the first packet 502-1 arrived. When the N+1 packet arrives, the first packet is dropped, the next-to-oldest packet will be the oldest packet, and the N+1 packet will be the newest packet, such that at any time typically there will be N packets, 502-1 through 502-N. This is a first-in, first-out (FIFO) type of arrangement.

If the DL packet flow is critical (Block 5A=Y), it is determined if the DL packet flow is also time-critical (Block 5F) (e.g., has the property of being time-critical). If the DL packet flow is both critical (Block 5A=Y) and time-critical (Block 5F=Y), in block 5G stored data packets 502 from memory 501 are communicated from the aGW 14 to BS2 and new packets (e.g., packets that have not been previously sent to BS1 and typically have not yet been stored in memory 501) in the DL packet flow are bi-cast to both BS1 and BS2. As stated above, typically there are N data packets 502 that are stored. Generally, Block 5G will not need more than the N data packets 502, as the stored packets 502-1 through 502-N can be communicated from the aGW 14 to the BS2 very quickly, before a new packet arrives. To put another way, when a new packet N+1 arrives, at least one of the packets 502-1 through 502-N will have been communicated to BS2, and the new packet N+1 will take the place of the oldest packet of packets 502-1 through 502-N. Thus, no more memory other than memory for packets 502-1 through 502-N is generally needed for Block 5G. This also means that the original N packets in memory 501 are quickly communicated to BS2 and there is typically only a short period of time until new packets that arrive are communicated to both BS1 and BS2 and also stored in memory 501.

If the DL packet flow is critical (Block 5A=Y) and not time-critical (Block 5B=N), the DL packet flow is paused but packets that arrive are stored (Block 5H). This storage of packets will therefore include more memory than typically included for critical flows. In other words, typically, data packets 502-1 through 502-N are used to hold packets for critical flows. Block 5H will cause another M packets to be stored, such that memory 501 will contain packets 502-1 through 502-M+N at the conclusion of Block 5H. In block 5I, the DL packet flow is restarted after UE 10 connects to BS2. The M+N packets stored 502 in memory 501 will be communicated by the aGW 14 to the BS2 in Block 5I.

Note that memory 301 may also be used for time-critical but non-critical DL packet flows. For instance, Block 5C might also store packets in memory 301 or packets might be stored in memory 301 at Operation B of FIG. 2. Operation B of FIG. 2 would typically take place prior to Block 5A of FIG. 5. Note also that blocks 5F, 5G, 5H, and 5I can be considered in broad terms to communicate to BS2 stored downlink packets previously sent to BS1 and communicate to at least BS2 downlink packets that have not been previously sent to BS1 and that arrive at the anchor node as part of the downlink packet flow.

The methods shown in FIGS. 3-5, performed, e.g., by aGW 14, could perform packet classification based on properties of the packets for the DL packet flow in a multi-phase analysis or in single phase analysis. A single phase analysis is an analysis where all properties (typically a plurality of properties) are determined. A multi-phase analysis is an analysis where not all properties are determined in any single phase of the analysis, and more than one phase is used to determine the properties, which are needed to choose the forwarding method (e.g., methods as show in FIGS. 3-5 and particularly shown in blocks 5C, 5D, 5E, 5G, 5H, and 5I of FIG. 5). One implementation of aGW 14 could use single phase analysis to determine all properties needed by forwarding decisions in blocks 5A, 5B, and 5F.

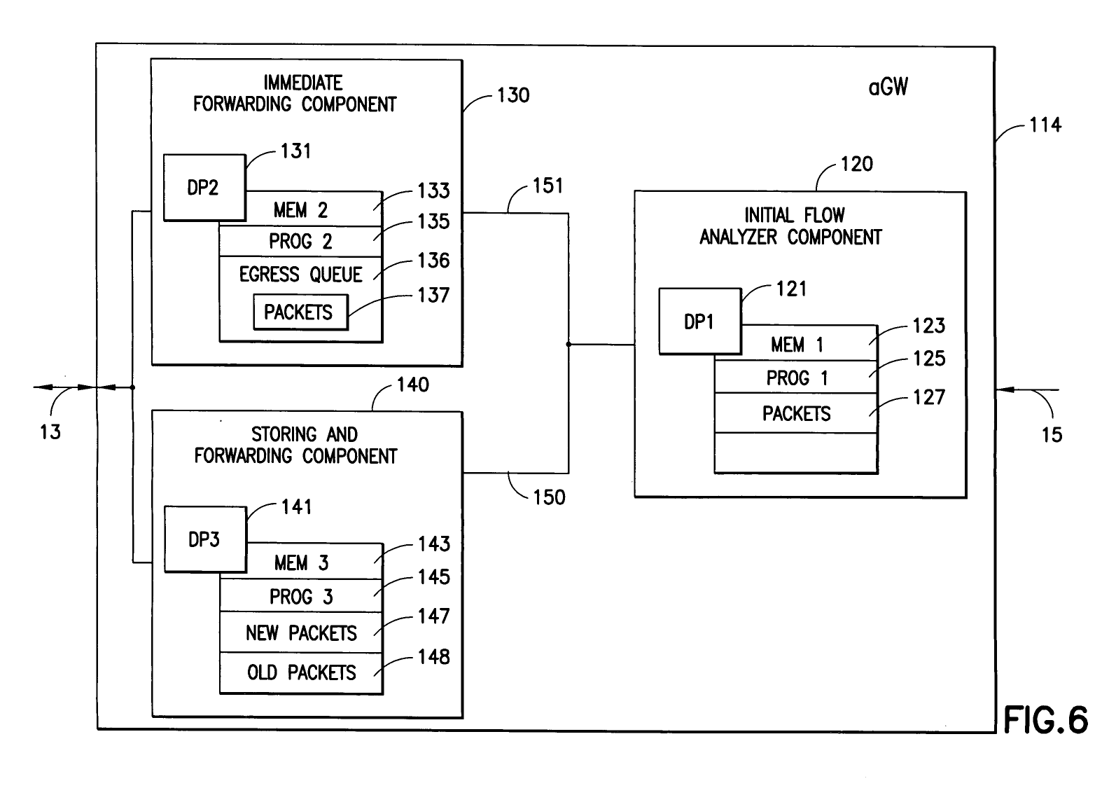

Another implementation of aGW 14 is shown in FIG. 6. In this figure, aGW 114 comprises an initial flow analyzer component 120, an immediate forwarding component 130, and a storing and forwarding component 140. The initial flow analyzer component 120 comprises one or more data processors 121 and one or more memories 123 including a program 125 and packets 127. The immediate forwarding component 130 comprises one or more data processors 131 and one or more memories 133 including a program 135 and an egress queue 136 containing packets 137. The storing and forwarding component 140 comprises one or more data processors 141 and one or more memories 143 including a program 145, new packets 147 (e.g., packets that have not been previously delivered to BS1) and old packets 148 (e.g., packets previously delivered to BS1). Each of the initial flow analyzer component 120, immediate forwarding component 130, storing and forwarding component 140 operate under direction (at least in part) of a corresponding program 125, 135, and 145, respectively. Each of the components 120,130, and 140 could be considered a separate apparatus and could be, e.g., separate physical elements such as separate packages coupled through buses or separate areas of an integrated circuit interconnected through buses. Furthermore, one or more of the components could be implemented as a special-purpose integrated circuit.

The aGW 114 could use several phases so that, e.g., a decision in block 5A of FIG. 5 is made based on the first phase in the initial flow analyzer component 120. Based on the decision made by the initial flow analyzer component 120, the packets 127 are communicated along either path 150 or path 151. Analysis for a decision in block 5B could be implemented in immediate forwarding component 130, i.e., packets 127 would be analyzed and dropped (block 5D) before putting into the egress queue 136 or put into the egress queue 136 as packets 137 and bi-cast to BS1 and BS2 (block 5C). Analysis for a decision of block 5F could be implemented in storing and forwarding component 140, which examines packets 127 and places the packets in the memory 143 as new packets 147 for storage in block 5H or for bi-casting the packets 127 directly to BS1 and BS2 (block 5G) with or without some temporary storage as new packets 147. As described above, the storing and forwarding component 140 also will typically send old packets 148 to BS2 (blocks 5I and 5G).

It should be noted that the order of decisions in FIG. 5 could be performed in any number of orders for a multi-phase analysis. For instance, analysis for the decisions in blocks 5B and 5F may in some implementations be performed before analysis for the decision in block 5A.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the exemplary embodiments of the invention are not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. Further, the individual blocks of the logic flow diagrams of FIGS. 3, 4, and 5 may be viewed as method steps, or as program modules of a computer program product, or as a collection of interconnected hardware/firmware logic units.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method, comprising:
during a handover of a user equipment (UE) from a first base station (BS1) to a second base station (BS2), determining at an anchor node at least one property of a downlink packet flow; and
bi-casting downlink packets in the downlink packet flow to BS1 and BS2 only when the at least one property of the downlink packet flow is determined to comprise at least one predetermined property.

2. The method of claim 1, where the at least one predetermined property comprises a time-critical property and where bi-casting further comprises bi-casting downlink packets in the downlink packet flow to BS1 and BS2 only when the at least one property of the downlink packet flow is determined to comprise the time-critical property.

3. The method of claim 2, where a flow having at least one property of a time-critical property is a flow associated with a real-time or substantially real-time event.

4. The method of claim 1, further comprising saving at the anchor node certain packets having the at least one property comprising a time-critical property that are sent to BS1 for sending later to BS2.

5. The method of claim 1, where if a certain packet flow is determined to have the at least one property of a not time-critical property, further comprising:
pausing sending of the certain packet flow; and
restarting the sending of the packet flow after the UE has connected to BS2.

6. The method of claim 5, where pausing further comprises dropping downlink packets that are part of the certain packet flow.

7. The method of claim 5, where pausing further comprises storing downlink packets that are part of the certain packet flow and restarting further comprises sending the stored downlink packets to BS2 after the UE has connected to BS2.

8. The method of claim 1, further comprising:
after the UE connects to BS2, informing BS2, on a per packet flow basis, of a sequence number of a last received packet from BS1; and
the BS2 informing the anchor node of at least those sequence numbers for flows not bi-cast to BS2.

9. The method of claim 1, where the at least one predetermined property comprises a predetermined quality of service (QoS) requirement of the downlink packet flow.

10. The method of claim 9, where bi-casting is performed in response to the at least one predetermined property comprising a first predetermined QoS requirement of the downlink packet flow, and where the method further comprises, in response to the at least one predetermined property comprising a second predetermined QoS requirement, pausing the sending of data packets to BS1, and restarting the sending of data packets to BS2.

11. The method of claim 1, where the at least one predetermined property comprises both a critical property and a time-critical property and where bi-casting further comprises bi-casting downlink packets that have not been previously communicated to BS1 and that are part of the downlink packet flow.

12. The method of claim 11, further comprising, in response to the at least one predetermined property comprising both a critical property and a time-critical property, communicating to BS2 stored downlink packets previously sent to BS1.

13. The method of claim 11, where the at least one predetermined property comprises a critical property but does not comprise a time-critical property, and where the method further comprises, in response to the at least one predetermined property comprising the critical property but not comprising the time-critical property, pausing sending of the downlink packet flow and storing the downlink packets that have not been previously communicated to BS1 and that are part of the downlink packet flow, and communicating to BS2 the stored downlink packets and also previously stored downlink packets that have already been previously communicated to BS1.

14. The method of claim 1, where the at least one property comprises a plurality of properties, where the method further comprises performing a plurality of decisions to perform bi-casting with or without pausing the packet flow and restarting sending to BS2 after the anchor node connects to BS2 and to perform bi-casting with or without sending stored packets to BS2 that were previously sent to BS1, and where the plurality of decisions are performed by a single component.

15. The method of claim 1, where the at least one property comprises a plurality of properties, where the method further comprises performing a plurality of decisions to perform bi-casting with or without pausing the packet flow and restarting sending to BS2 after the anchor node connects to BS2 and to perform bi-casting with or without sending stored packets to BS2 that were previously sent to BS1, and where the plurality of decisions are performed by at least two components.

16. A network node, comprising:
means, responsive during a handover of a user equipment (UE) from a first base station (BS1) to a second base station (BS2), for determining at least one property of a downlink packet flow; and
means, responsive to the determination, for bi-casting downlink packets in the downlink packet flow to BS1 and BS2 only when the at least one property of the downlink packet flow determined to comprise at least one predetermined property.

17. The network node of claim 16, where the at least one predetermined property comprises a time-critical property and where the means for bi-casting further comprises means for bi-casting downlink packets in the downlink packet flow to BS1 and BS2 only when the at least one property of the downlink packet flow is determined to comprise the time-critical property.

18. The network node of claim 17, where a flow having at least one property of a time-critical property is a flow associated with a real-time or substantially real-time event.

19. The network node of claim 16, further comprising means for saving certain packets having the at least one property comprising a time-critical property are sent to BS1 for sending later to BS2.

20. The network node of claim 16, where if a certain packet flow is determined to have the at least one property of a not time-critical property, further comprising:
means for pausing sending of the certain packet flow; and
means for restarting the sending of the packet flow after the UE has connected to BS2.

21. The network node of claim 20, where the means for pausing further comprises means for dropping downlink packets that are part of the certain packet flow.

22. The network node of claim 20, where the means for pausing further comprises means for storing downlink packets that are part of the certain packet flow and the means for restarting further comprises means for sending the stored downlink packets to BS2 after the UE has connected to BS2.

23. The network node of claim 16, further comprising:
means, responsive to the UE connecting to BS2, for informing BS2, on a per packet flow basis, of a sequence number of a last received packet from BS1; and
means for receiving BS2 informion of at least those sequence numbers for flows not bi-cast to BS2.

24. The network node of claim 16, where the at least one predetermined property comprises a predetermined quality of service (QoS) requirement of the downlink packet flow.

25. The network node of claim 24, where the means for bi-casting performs bi-casting in response to the at least one predetermined property comprising a first predetermined QoS requirement of the downlink packet flow, and where the network node further comprises means, responsive to the at least one predetermined property comprising a second predetermined QoS requirement, for pausing the sending of data packets to BS1, and means for restarting the sending of data packets to BS2.

26. The network node of claim 16, where the at least one predetermined property comprises both a critical property and a time-critical property and where the means for bi-casting further comprises means for bi-casting downlink packets that have not been previously communicated to BS1 and that are part of the downlink packet flow.

27. The network node of claim 26, further comprising means, responsive to the at least one predetermined property comprising both a critical property and a time-critical property, for communicating to BS2 stored downlink packets previously sent to BS1.

28. The network node of claim 26, where the at least one predetermined property comprises a critical property but does not comprise a time-critical property, and where the network node further comprises means, responsive to the at least one predetermined property comprising the critical property but not comprising the time-critical property, for pausing sending of the downlink packet flow and means for storing the downlink packets that have not been previously communicated to BS1 and that are part of the downlink packet flow, and means for communicating to BS2 the stored downlink packets and also previously stored downlink packets that have already been previously communicated to BS1.

29. The network node of claim 16, where the at least one property comprises a plurality of properties, where the network node further comprises a single component for performing a plurality of decisions to perform bi-casting with or without pausing the packet flow and restarting sending to BS2 after the anchor node connects to BS2 and to perform bi-casting with or without sending stored packets to BS2 that were previously sent to BS1.

30. The network node of claim 16, where the at least one property comprises a plurality of properties, where the network node further comprises at least two components performing a plurality of decisions to perform bi-casting with or without pausing the packet flow and restarting sending to BS2 after the anchor node connects to BS2 and to perform bi-casting with or without sending stored packets to BS2 that were previously sent to BS1.

31. A computer program product embodied in at least one computer readable storage media and comprising program instructions execution of which by at least one data processor of a network node results in operations comprising:
during a handover of a user equipment (UE) from a first base station (BS1) to a second base station (BS2), determining at an anchor node at least one property of a downlink packet flow as the property; and
bi-casting downlink packets in the downlink packet flow to BS1 and BS2 only when the at least one property of the downlink packet flow is determined to comprise at least one predetermined property.

32. The computer program product of claim 31, where the at least one predetermined property comprises a time-critical property and where bi-casting further comprises bi-casting downlink packets in the downlink packet flow to BS1 and BS2 only when the at least one property of the downlink packet flow is determined to comprise the time-critical property.

33. The computer program product of claim 31, where the at least one predetermined property comprises a predetermined quality of service (QoS) requirement of the downlink packet flow.

34. The computer program product of claim 31, where the at least one predetermined property comprises both a critical property and a time-critical property and where bi-casting further comprises bi-casting downlink packets that have not been previously communicated to BS1 and that are part of the downlink packet flow.

35. An apparatus, comprising:
at least one memory comprising program code; and
at least one data processor coupled to the at least one memory, the at least one data processor when executing the program code is configured to perform the following operations:
during a handover of a user equipment (UE) from a first base station (BS1) to a second base station (BS2), determining at least one property of a downlink packet flow; and
bi-casting downlink packets in the downlink packet flow to BS1 and BS2 only when the at least one property of the downlink packet flow is determined to comprise at least one predetermined property.

36. The apparatus of claim 35, where the at least one data processor comprises a plurality of interconnected data processors, the at least one memory comprises a plurality of memories, and each memory comprises a portion of the program code.
